(19) United States
(12) Patent Application Publication
(10) Pub. No.: US 2008/0266287 A1
(43) Pub. Date: Oct. 30, 2008

(54) DECOMPRESSION OF VERTEX DATA USING A GEOMETRY SHADER

(75) Inventors: William Orville Ramey, Santa Clara, CA (US); Henry Packard Moreton, Woodside, CA (US); Douglas H. Rogers, Gilroy, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: NVIDIA Corporation, Santa Clara, CA (US)

(21) Appl. No.: 11/740,016

(22) Filed: Apr. 25, 2007

(51) Int. Cl. G06T 15/00

(52) U.S. Cl. 345/419

(57) ABSTRACT

A geometry shader of a graphics processor decompresses a set of vertex data representing a simplified model to create a more detailed representation. The geometry shader receives vertex data including a number of vertices representative of a simplified model. The geometry shader decompresses the vertex data by computing additional vertices to create the more detailed representation. In some embodiments, the geometry shader also receives rules data including information on how the vertex data is to be decompressed.

### BACKGROUND OF THE INVENTION

The present invention relates in general to computer graphics, and in particular to the decompression of a set of vertex data in a graphics processor.

Many computer generated images are created by mathematically modeling the interaction of light with a three-dimensional (3D) scene from a given viewpoint and projecting the result onto a two-dimensional (2D) “screen.” This process, called rendering, generates a 2D image of the scene from the given viewpoint and is analogous to taking a digital photograph of a real-world scene.

As the demand for computer graphics, and in particular for real-time computer graphics, has increased, computer systems with graphics processing subsystems adapted to accelerate the rendering process have become widespread. In these computer systems, the rendering process is often divided between a computer's general-purpose central processing unit (CPU) and a graphics processing subsystem. Typically, the CPU performs high-level operations, such as determining the position, motion, and collision of objects in a given scene. From these high-level operations, the CPU generates a set of rendering commands and data defining the desired rendered image (or images). For example, rendering commands and data can define scene geometry by reference to groups of vertices. Groups of points, lines, triangles and/or other simple polygons defined by the vertices may be referred to as “primitives.” Each vertex or set of vertices may have attributes such as color, world space coordinates, texture-map coordinates, and the like. Rendering commands and data can also define other parameters for a scene, such as lighting, shading, textures, motion, and/or camera position. From the set of rendering commands and data, the graphics processing subsystem creates one or more rendered images.

Graphics processing subsystems typically use a stream, or pipeline, processing model, in which input elements are read and operated on successively by a chain of processing units. The output of one processing unit is the input to the next processing unit in the chain. A typical pipeline includes a number of processing units, which generate attribute values for the 2D or 3D vertices, create parameterized attribute equations for points in each primitive, and determine which particular pixels or sub-pixels are covered by a given primitive. Typically, data flows one way, “downstream,” through the chain of units, although some processing units may be operable in a “multi-pass” mode, in which data that has already been processed by a given processing unit can be returned to that unit (or a previous or other unit) for additional processing.

Typically, the data sent to the graphics processing subsystem defines a set of vertices to be used in rendering the final image. Often, more vertices than are necessary to render the final scene are processed through at least part of the graphics pipeline. However, sending the entire set of vertices to be rendered may be a strain on bandwidth available between a CPU/system memory and the GPU. Many computer graphics applications require complex, detailed models. As rendered scenes become more complex, they typically include a larger number of vertices. Processing bottlenecks can occur, for instance, if the graphics subsystem does not provide sufficient bandwidth to communicate all of the vertices and their associated attributes through various units of the pipeline.

It is therefore desirable to send condensed vertex data through select parts of the graphics pipeline, in order to decrease excess rendering operations, reduce the bandwidth requirements for communicating vertices and associated attributes, and improve rendering performance.

### BRIEF SUMMARY OF THE INVENTION

Embodiments of the present invention provide for decompressing a set of vertex data representing a simplified model to create a more detailed representation. In one embodiment, a geometry shader of a graphics processor receives a set of vertex data representative of a simplified model. The geometry shader decompresses the vertex data by computing additional vertices to create the more detailed representation. In some embodiments, the geometry shader also receives rules data including information on how the vertex data is to be decompressed. To the extent that data for a higher resolution model is compressed into simplified vertex data and control data with parameters for decompression, less data is delivered through the pipeline. This may reduce bottlenecks and improve throughput in the graphics pipeline.

In one set of embodiments, a method of processing vertex data to create a more detailed version thereof is described. Vertex data for a first set of vertices representative of a simplified model is forwarded (e.g., by a vertex shader or other upstream processing unit). The vertex data is decompressed at a geometry shader of a graphics processor, to create a more detailed representation of the simplified model including a number of additional vertices. The more detailed representation may be a subdivided version of the simplified model including a plurality of additional vertices. Different subsets of the first set of vertices may be subdivided to different degrees. Also texture data and other attributes may be applied to at least some of the additional vertices which does not apply to any of the first set of vertices.

In one embodiment, a set of rules data is created, the set including rules for the decompression of the simplified model. The set of rules data is passed to the geometry shader which then decompresses the simplified model using the set of rules data. The set of rules data may include a subdivision rule, texture rule, texture projection rule, edge rule, boundary rule, ray-casting rule, seam rule, other per-vertex attribute, or other parameter for the decompression. In one embodiment, the set of rules data includes a rule to be applied to only a subset of the first set of vertices. For example, the set of rules data may identify a first subset of the first set of vertices which is to be subdivided to a greater level of detail than a second subset of the first set of vertices. In another embodiment, the geometry shader computes additional vertices using the set of rules data and the vertex data, the rules data identifying parameters for the additional vertices to be computed.

The simplified model may include triangles, quadrilaterals, and other polygons, or any combination thereof. In one embodiment, vertex data for a second set of vertices are simplified to produce the simplified model, wherein the second set of vertices is greater in number than the first set of vertices. In one embodiment, the vertex data for the second set of vertices is compressed into a set of data including the vertex data for the first set of vertices and rules data including rules for the decompression of the simplified model. The compressed set of data is passed in lieu of the vertex data for the second set of vertices. A normal map may then be applied to the more detailed representation of the simplified model, the normal map made up of differences between texture coordinates of the first set of vertices and texture coordinates of the second set of vertices.

In an alternative set of embodiments, a graphics processor includes a geometry shader and one or more upstream processing units. The upstream processor may, for example, be a vertex shader. The one or more upstream processing units are configured to pass vertex data for a first set of vertices representative of a simplified model to the geometry shader. The geometry shader, communicatively connected with the upstream units, is configured to receive and decompress the vertex data to create a more detailed representation of the simplified model. In one embodiment, the geometry shader is configured to subdivide the first set of vertices in the decompression of the vertex data to thereby create the more detailed representation. The geometry shader may, in one embodiment, be further configured to subdivide certain subsets of the vertices to different degrees.

In one embodiment, the one or more upstream processing units are further configured to receive a set of rules data including rules for the decompression of the simplified model. The upstream processing units pass the set of rules data to the geometry shader including rules for the decompression of the simplified model. The geometry shader may, thus, be configured to decompress the simplified model using the set of rules data. The set of rules data may include one or more of the following: a subdivision rule, tessellation rule, texture rule, texture projection rule, edge rule, boundary rule, ray-casting rule, seam rule, other per-vertex attribute rule, and other parameter for the decompression. The set of rules data may include rules to be applied to only a subset of the first set of vertices. For example, the set of rules data may identify a first subset of the vertices which is to be subdivided to a greater level of detail than a second subset. In another embodiment, the set of rules data identifies rules to be applied only to certain additional vertices computed via the decompression, and not applied to the first set of vertices. Note also that in one embodiment, the set of rules data identifies parameters of the additional vertices to be computed, and the geometry shader is configured to compute additional vertices in the creation of the more detailed representation. In another embodiment, the geometry shader is preprogrammed with a set of rules data to apply in the decompression of the vertex data.

Finally, note that in one embodiment a pixel shader is communicatively connected with the one or more upstream processing units. The pixel shader is configured to apply a normal map to the more detailed representation of the simplified model, the normal map made up of differences between texture coordinates of the first set of vertices and texture coordinates of a detailed version of the simplified model.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a computer system configured according to various embodiments of the present invention;

FIG. 2 is a block diagram of a rendering pipeline of a graphics processing subsystem configured according to various embodiments of the present invention;

FIG. 3 is a block diagram of a multithreaded core array configured according to various embodiments of the present invention;

FIG. 4 is a block diagram illustrating shader units of a rendering pipeline configured according to various embodiments of the present invention;

FIG. 5 illustrates subdivision operations according to various embodiments of the present invention;

FIG. 6 illustrates a comparison between two sets of vertices modeled to different levels of details according to various embodiments of the present invention;

FIG. 7 illustrates a comparison between five sets of vertices modeled to different levels of details according to various embodiments of the present invention;

FIG. 8 is a flowchart illustrating a method of decompressing vertex data using a geometry shader according to various embodiments of the present invention;

FIG. 9 is a flowchart illustrating an alternative method of decompressing vertex data using a geometry shader according to various embodiments of the present invention; and

FIG. 10 is a flowchart illustrating a method of decompressing vertex data and creating additional vertices according to various embodiments of the present invention.

### DETAILED DESCRIPTION OF THE INVENTION

This description provides exemplary embodiments only, and is not intended to limit the scope, applicability or configuration of the invention. Rather, the ensuing description of the embodiments will provide those skilled in the art with an enabling description for implementing embodiments of the invention. Various changes may be made in the function and arrangement of elements without departing from the spirit and scope of the invention as set forth in the appended claims.

Thus, various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments.

It should also be appreciated that the following systems, methods, and software may be a component of a larger system, wherein other procedures may take precedence over or otherwise modify their application. Also, a number of steps may be required before, after, or concurrently with the following embodiments.

According to various embodiments of the invention, a processing engine of a graphics processor decompresses a set of vertex data representing a simplified model to create a more detailed representation. The processing engine receives vertex data including a number of vertices representative of a simplified model. The processing engine decompresses the vertex data by computing additional vertices to create the more detailed representation. In some embodiments, the processing engine also receives rules data including information on how the vertex data is to be decompressed.

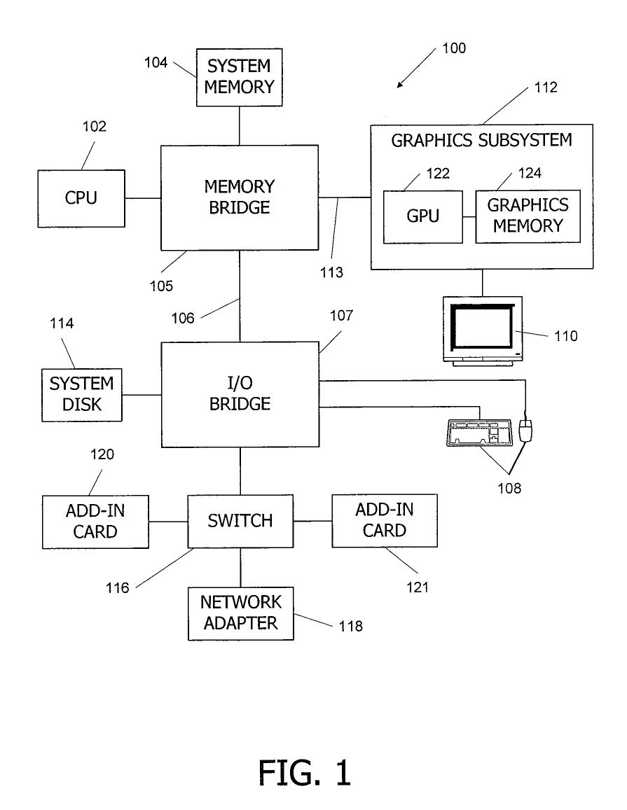

FIG. 1 is a block diagram of a computer system 100 according to one embodiment of the present invention. Computer system 100 includes a central processing unit (CPU) 102 and a system memory 104 communicating via a bus path that includes a memory bridge 105. Memory bridge 105, which may be, e.g., a conventional Northbridge chip, is connected via a bus or other communication path 106 (e.g., a HyperTransport link) to an I/O (input/output) bridge 107. I/O bridge 107, which may be, e.g., a conventional Southbridge chip, receives user input from one or more user input devices 108 (e.g., keyboard, mouse) and forwards the input to CPU 102 via bus 106 and memory bridge 105. Visual output is provided on a pixel based display device 110 (e.g., a conventional CRT or LCD based monitor) operating under control of a graphics subsystem 112 coupled to memory bridge 105 via a bus or other communication path 113, e.g., a PCI Express (PCI-E) or Accelerated Graphics Port (AGP) link. A system disk 114 is also connected to I/O bridge 107. A switch 116 provides connections between I/O bridge 107 and other components such as a network adapter 118 and various add-in cards 120, 121. Other components (not explicitly shown), including USB or other port connections, CD drives, DVD drives, and the like, may also be connected to I/O bridge 107. Bus connections among the various components may be implemented using bus protocols such as PCI (Peripheral Component Interconnect), PCI-E, AGP, HyperTransport, or any other bus or point-to-point communication protocol(s), and connections between different devices may use different protocols as known in the art.

Graphics processing subsystem 112 includes a graphics processing unit (GPU) 122 and a graphics memory 124, which may be implemented, e.g., using one or more integrated circuit devices such as programmable processors, application specific integrated circuits (ASICs), and memory devices. GPU 122 may be configured to perform various tasks related to generating pixel data from graphics data supplied by CPU 102 and/or system memory 104 via memory bridge 105 and bus 113, interacting with graphics memory 124 to store and update pixel data, and the like. For example, GPU 122 may generate pixel data from 2-D or 3-D scene data provided by various programs executing on CPU 102. GPU 122 may also store pixel data received via memory bridge 105 to graphics memory 124 with or without further processing. GPU 122 also includes a scanout module configured to deliver pixel data from graphics memory 124 to display device 110.

CPU 102 operates as the master processor of system 100, controlling and coordinating operations of other system components. In particular, CPU 102 issues commands that control the operation of GPU 122. In some embodiments, CPU 102 writes a stream of commands for GPU 122 to a command buffer, which may be in system memory 104, graphics memory 124, or another storage location accessible to both CPU 102 and GPU 122. GPU 122 reads the command stream from the command buffer and executes commands asynchronously with operation of CPU 102. The commands may include conventional rendering commands for generating images as well as general-purpose computation commands that enable applications executing on CPU 102 to leverage the computational power of GPU 122 for data processing that may be unrelated to image generation.

In one embodiment, CPU 102 executes one or more programs to simplify polygonal models. The computer system 100 may receive or otherwise produce geometry data which includes, for example, objects defined by a number of vertices. As noted above, many computer graphics applications have highly detailed models, which may have significant computational costs. CPU 102 may simplify a more detailed model in any manner known in the art, such as vertex decimation, vertex clustering, or iterative edge contraction. The simplification may also be performed manually using such software applications as are commonly used in the art. In different embodiments, the simplification may be performed at different times (e.g. as part of the content authoring process, when the rendering application that sends the data to the GPU 122 is first loaded, or on-the-fly as needed while the rendering application is rendering). With the simplification, CPU 102 may create or otherwise identify vertex data for a reduced number of vertices representative of a simplified model (i.e., a control net). CPU 102 may forward this vertex data to the rendering pipeline of GPU 122.

In conjunction with the simplification, CPU 102 may execute a program to create a set of rules data, with rules to decompress the vertex data to create a more detailed representation of the simplified model. The rules data may be included with or otherwise integrated into per-vertex attributes. The rules may include one or more subdivision rules, tessellation rules, texture rules, texture projection rules, edge rules, boundary rules, ray-casting rules, seam rules, other per-vertex attribute rules, and/or any other parameters for the decompressing the vertex data. The rules may be applied to only a subset of the set of vertices, or may be applied on a per-vertex basis. While in some embodiments the rules data may be used to process the vertex data to create the more detailed representation, in other embodiments the vertex data may be decompressed in other ways (e.g., when a geometry shader is preprogrammed). CPU 102 may forward this rules data to the rendering pipeline of GPU 122.

In one embodiment, the CPU 102 may execute a program which identifies differences between texture coordinates of a set of vertices representing a more detailed model and texture coordinates of the set of vertices representing the simplified model, to thereby create a normal map. A normal map may, in other embodiments, be data representing another comparison between attributes of a more detailed model and attributes of a simplified model. The CPU 102 may forward this normal data to the rendering pipeline of the GPU 122.

Also, it is worth noting that any combination of the vertex data, rules data, and normal data may be received via the network adapter 118, or otherwise, from an external computing device local or remote to the system. In one embodiment, the simplification and rules commands may be executed, in whole or in part, by the GPU 122.

It will be appreciated that the system shown herein is illustrative and that variations and modifications are possible. The bus topology, including the number and arrangement of bridges, may be modified as desired. For instance, in some embodiments, system memory 104 is connected to CPU 102 directly rather than through a bridge, and other devices communicate with system memory 104 via memory bridge 105 and CPU 102. In other alternative topologies, graphics subsystem 112 is connected to I/O bridge 107 rather than to memory bridge 105. In still other embodiments, I/O bridge 107 and memory bridge 105 might be integrated into a single chip. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

The connection of GPU 122 to the rest of system 100 may also be varied. In some embodiments, graphics system 112 is implemented as an add-in card that can be inserted into an expansion slot of system 100. In other embodiments, a GPU is integrated on a single chip with a bus bridge, such as memory bridge 105 or I/O bridge 107. In still other embodiments, some or all elements of GPU 122 may be integrated with CPU 102.

A GPU may be provided with any amount of local graphics memory, including no local memory, and may use local memory and system memory in any combination. For instance, in a unified memory architecture (UMA) embodiment, no dedicated graphics memory device is provided, and the GPU uses system memory exclusively or almost exclusively. In UMA embodiments, the GPU may be integrated into a bus bridge chip or provided as a discrete chip with a high-speed bus (e.g., PCI-E) connecting the GPU to the bridge chip and system memory.

It is also to be understood that any number of GPUs may be included in a system, e.g., by including multiple GPUs on a single graphics card or by connecting multiple graphics cards to bus 113. Multiple GPUs may be operated in parallel to generate images for the same display device or for different display devices.

In addition, GPUs embodying aspects of the present invention may be incorporated into a variety of devices, including general purpose computer systems, video game consoles and other special purpose computer systems, DVD players, handheld devices such as mobile phones or personal digital assistants, and so on.

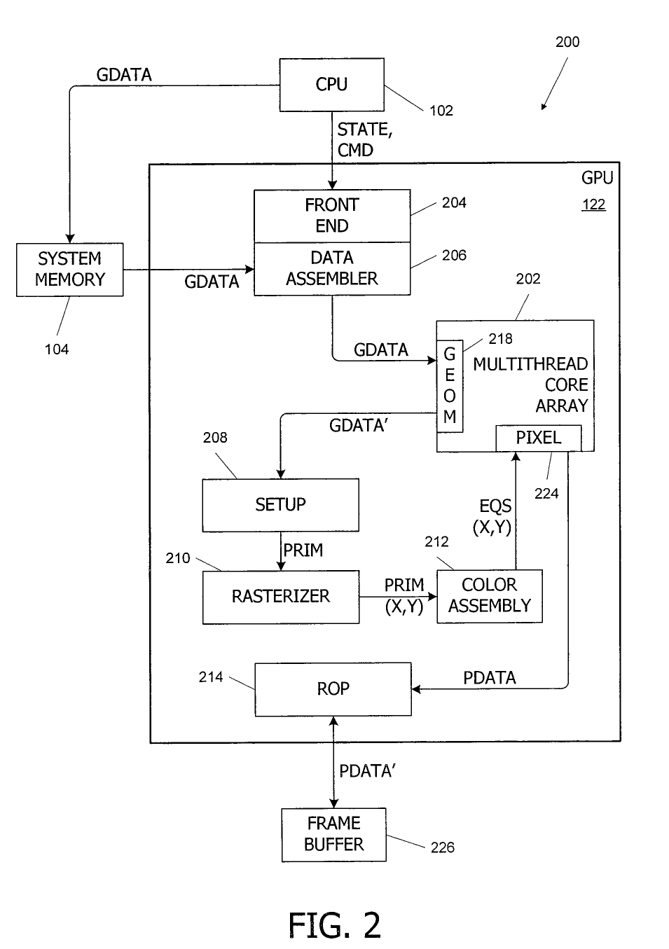

FIG. 2 is a block diagram of a rendering pipeline 200 that can be implemented in GPU 122 of FIG. 1 according to an embodiment of the present invention. In this embodiment, the rendering pipeline 200 is configured to receive the vertex data representing the simplified model from the CPU 102. It may also receive rules data and normal data. The rendering pipeline 200 in this embodiment is implemented using an architecture in which any applicable vertex shader programs, geometry shader programs, and pixel shader programs are executed using the same parallel-processing hardware, referred to herein as a “multithreaded core array” 202. Multithreaded core array 202 is described further below.

In addition to multithreaded core array 202, rendering pipeline 200 includes a front end 204 and data assembler 206, a setup module 208, a rasterizer 210, a color assembly module 212, and a raster operations module (ROP) 214, each of which can be implemented using conventional integrated circuit technologies or other technologies.

Front end 204 receives state information (STATE), rendering commands (CMD), and geometry data (GDATA), e.g., from CPU 102 of FIG. 1. In some embodiments, rather than providing geometry data directly, CPU 102 provides references to locations in system memory 104 at which geometry data is stored; data assembler 206 retrieves the data from system memory 104. Rules data may be included with or otherwise integrated into state information. Apart from the rules data, the state information, rendering commands, and geometry data may be of a generally conventional nature and may be used to define the desired rendered image or images, including geometry, lighting, shading, texture, motion, and/or camera parameters for a scene.

In one embodiment, the geometry data includes a number of object definitions for objects (e.g., a table, a chair, a person or animal) that may be present in the scene. Thus, the geometry data may include the simplified vertex data: i.e., the vertex data for a reduced number of vertices representative of a simplified model. In one embodiment, the geometry data may instead include vertex data for an “unsimplified” set of vertices (i.e., a highly detailed set of vertices), and a downstream processing unit (e.g., in the multithreaded core array 202) may perform the simplification.

Some additional discussion regarding vertex data may be worthwhile. Objects may be modeled as groups of points, lines, triangles and/or other polygons (often referred to as “primitives”), and thus objects may be defined by reference to their vertices. For each vertex, a position is specified in an object coordinate system, representing the position of the vertex relative to the object being modeled. In addition to a position, each vertex may have various other attributes associated with it. In general, attributes of a vertex may include any property that is specified on a per-vertex basis; for instance, in some embodiments, the vertex attributes include scalar or vector attributes used to determine qualities such as the color, texture, transparency, lighting, shading, and animation of the vertex and its associated geometric primitives. In one embodiment, the rules data described above may be included or otherwise integrated into the per-vertex attributes. Thus, the rules for processing vertex data to create a more detailed representation of the simplified model may be included with the per-vertex attributes. The per-vertex attributes may, therefore, include rules for the subdivision(s) related to its vertex. The per-vertex attributes may also include rules (i.e., subdivision rules, texture rules, texture projection rules, edge rules, boundary rules, ray-casting rules, seam rules, other rules or parameters) to be applied to the additional vertices created when the vertex data is decompressed.

Primitives, as noted, may be characterized as a set or subset of vertices, and are generally defined by reference to their vertices. A single vertex may be included in any number of primitives. In some embodiments, each vertex is assigned an index (which may be any unique identifier), and a primitive may be defined by providing an ordered list of indices for the vertices making up that primitive. Other techniques for defining primitives (including conventional techniques such as triangle strips or fans) may also be used. Thus, the set of vertices associated with a primitive may make up the set of vertices associated with the simplified model. Alternatively, the set of vertices of the simplified model may include more than one primitive, or only a part of a primitive. In other words, simplification and subdivision may, but need not, occur on a per-primitive basis.

The state information and rendering commands define processing parameters and actions for various stages of rendering pipeline 200. Front end 204 may direct the state information and rendering commands via a control path (not explicitly shown) to other components of rendering pipeline 200. As noted above, state information may include rules data. As is known in the art, these components may respond to received state information by storing or updating values in various control registers that are accessed during processing and may respond to rendering commands by processing data received in the pipeline.

Front end 204 directs the geometry data (i.e., the simplified set of vertex data and, perhaps, associated per-vertex attributes which may include rules data) to data assembler 206. Data assembler 206 formats the geometry data and prepares it for delivery to a geometry module 218 in multithreaded core array 202.

Geometry module 218 directs programmable processing engines (not explicitly shown) in multithreaded core array 202 to execute vertex and/or geometry shader programs on the vertex data, with the programs being selected in response to the state information provided by front end 204. The vertex and/or geometry shader programs can be specified by the rendering application, and different shader programs can be applied to different vertices and/or primitives. The shader program(s) to be used can be stored in system memory or graphics memory and identified to multithreaded core array 202 via suitable rendering commands and state information as is known in the art. In some embodiments, vertex shader and/or geometry shader programs can be executed in multiple passes, with different processing operations being performed during each pass. Each vertex and/or geometry shader program may determine the number of passes and the operations to be performed during each pass. The number of passes may, in one embodiment, be specified or otherwise indicated in the set of rules data. Vertex and/or geometry shader programs can implement algorithms using a wide range of mathematical and logical operations on vertices and other data, and the programs can include conditional or branching execution paths and direct and indirect memory accesses. The conditional or branching execution paths may be modified or otherwise dictated by the set of rules data.

Vertex shader programs and geometry shader programs can be used to implement a variety of visual effects, including lighting and shading effects. For instance, in a simple embodiment, a vertex shader program transforms a vertex from its 3D object coordinate system to a 3D clip space or world space coordinate system. This transformation defines the relative positions of different objects in the scene. In one embodiment, the transformation can be programmed by including, in the rendering commands and/or data defining each object, a transformation matrix for converting from the object coordinate system of that object to clip space coordinates. The vertex shader program applies this transformation matrix to each vertex making up an object. More complex vertex shader programs can be used to implement a variety of visual effects, including lighting and shading, procedural geometry, and animation operations. Numerous examples of such per-vertex operations are known in the art, and a detailed description is omitted as not being critical to understanding the present invention. In some embodiments, the vertex shader program receives the vertex data representative of the simplified model, and may also receive the rules data associated therewith. The vertex shader program can then transform the set of vertices from its 3D object coordinate system to a 3D clip space or world space coordinate system, and perform other operations described above.

Geometry shader programs differ from vertex shader programs in that geometry shader programs operate on groups of vertices (e.g., primitives) rather than individual vertices. Thus, in some instances, a geometry shader program creates new vertices and/or removes vertices or primitives from the set of objects being processed. In some embodiments, passes through a vertex shader program and a geometry shader program can be alternated to process the geometry data. In one embodiment, the geometry shader program is configured to receive and process the rules data. Thus, in accordance with the rules, the geometry shader may subdivide the vertex data for the set of vertices to create new vertices, create new vertices in other ways, apply texture and shading to existing and new vertices, and apply various edge, boundary, ray-casting, seam, and other rules, or parameters.

The geometry shader may utilize the vertex data for the simplified model in the creation of additional vertices (e.g., via subdivision or otherwise). The geometry shader may be preprogrammed to perform the subdivision, and/or may be configured to create a more detailed representation by decompressing the vertex data according to the rules data. As additional vertices are created by the geometry shader, they may be returned to the vertex shader programs for further processing. In some embodiments, the geometry shader receives the set of vertices of the simplified model as vertex data from the vertex shader; in other embodiments, other units may forward vertex data for a set of vertices to the geometry shader.

In some embodiments, vertex shader programs and geometry shader programs are executed using the same programmable processing engines in multithreaded core array 202. Thus, at certain times, a given processing engine may operate as a vertex shader, receiving and executing vertex shader program instructions, and at other times the same processing engine may operate as a geometry shader, receiving and executing geometry shader program instructions. The processing engines can be multithreaded, and different threads executing different types of shader programs may be in flight concurrently in multithreaded core array 202.

After the vertex and/or geometry shader programs have executed, geometry module 218 passes the processed geometry data (GDATA′) to setup module 208. This GDATA′ may include vertex data for the set of vertices making up the more detailed versions of the simplified model. Thus, both the vertex data for the set of vertices representative of the simplified model and vertex data for the additional vertices computed to create the more detailed version may be forwarded. Setup module 208, which may be of generally conventional design, generates edge equations from the clip space or screen space coordinates of each set of vertices; the edge equations may be usable to determine whether a point in screen space is inside or outside the set of vertices.

Setup module 208 may provide each primitive (PRIM) to rasterizer 210. Note that in other embodiments, one or more sets of vertices may be provided to rasterizer 210 without a one-to-one correspondence with a particular primitive, but for purposes of discussion assume that the set of vertices for a particular primitive are provided together to rasterizer 210. Rasterizer 210, which may be of generally conventional design, determines which (if any) pixels are covered by the primitive, e.g., using conventional scan-conversion algorithms. As used herein, a “pixel” (or “fragment”) refers generally to a region in 2-D screen space for which a single color value is to be determined; the number and arrangement of pixels can be a configurable parameter of rendering pipeline 200 and might or might not be correlated with the screen resolution of a particular display device. As is known in the art, pixel color may be sampled at multiple locations within the pixel (e.g., using conventional supersampling or multisampling techniques), and in some embodiments, supersampling or multisampling is handled within the pixel shader.

After determining which pixels are covered, rasterizer 210 provides the primitive (PRIM), along with a list of screen coordinates (X,Y) of the pixels covered by the primitive, to a color assembly module 212. Color assembly module 212 associates the primitives and coverage information received from rasterizer 210 with attributes (e.g., color components, texture coordinates, surface normals) of the vertices of the primitive and generates plane equations (or other suitable equations) defining some or all of the attributes as a function of position in screen coordinate space.

Color assembly module 212 provides the attribute equations (EQS, which may include e.g., the plane-equation coefficients A, B and C) for each primitive that covers at least one sampling location of a pixel and a list of screen coordinates (X,Y) of the covered pixels to a pixel module 224 in multithreaded core array 202. The functions of one or more of these units (setup 208, rasterizer 210, color assembly 212) may be performed by one of the processing engines of the multithreaded core array 202, as well. Pixel module 224 directs programmable processing engines (not explicitly shown) in multithreaded core array 202 to execute one or more pixel shader programs on each pixel covered by the primitive, with the program(s) being selected in response to the state information provided by front end 204. As with vertex shader programs and geometry shader programs, rendering applications can specify the pixel shader program to be used for any given set of pixels. Pixel shader programs can be used to implement a variety of visual effects, including lighting and shading effects, reflections, texture blending, procedural texture generation, and so on. Numerous examples of such per-pixel operations are known in the art and a detailed description is omitted as not being critical to understanding the present invention. Pixel shader programs can implement algorithms using a wide range of mathematical and logical operations on pixels and other data, and the programs can include conditional or branching execution paths and direct and indirect memory accesses. The pixel shader programs may be executed according to the rules data.

Pixel shader programs may apply a normal map to the set of vertices which make up the more detailed representation of the simplified model. The application of the normal map may produce data which can be used to further enhance or refine the applicable pixels of the image.

In this embodiment, pixel shader programs are advantageously executed in multithreaded core array 202 using the same programmable processing engines that also execute the vertex and/or geometry shader programs. Thus, at certain times, a given processing engine may operate as a vertex shader, receiving and executing vertex shader program instructions; at other times the same processing engine may operate as a geometry shader, receiving and executing geometry shader program instructions; and at still other times the same processing engine may operate as a pixel shader, receiving and executing pixel shader program instructions. It will be appreciated that the multithreaded core array can provide natural load-balancing: where the application is geometry intensive (e.g., many small primitives), a larger fraction of the processing cycles in multithreaded core array 202 will tend to be devoted to vertex and/or geometry shaders, and where the application is pixel intensive (e.g., fewer and larger primitives shaded using complex pixel shader programs with multiple textures and the like), a larger fraction of the processing cycles will tend to be devoted to pixel shaders.

Once processing for a pixel or group of pixels is complete, pixel module 224 provides the processed pixels (PDATA) to ROP 214. ROP 214, which may be of generally conventional design, integrates the pixel values received from pixel module 224 with pixels of the image under construction in frame buffer 226, which may be located, e.g., in graphics memory 124. In some embodiments, ROP 214 can mask pixels or blend new pixels with pixels previously written to the rendered image. Depth buffers, alpha buffers, and stencil buffers can also be used to determine the contribution (if any) of each incoming pixel to the rendered image. Pixel data PDATA′ corresponding to the appropriate combination of each incoming pixel value and any previously stored pixel value is written back to frame buffer 226. Once the image is complete, frame buffer 226 can be scanned out to a display device and/or subjected to further processing.

It will be appreciated that the rendering pipeline described herein is illustrative and that variations and modifications are possible. The pipeline may include different units from those shown and the sequence of processing events may be varied from that described herein. Further, multiple instances of some or all of the modules described herein may be operated in parallel. In one such embodiment, multithreaded core array 202 includes two or more geometry modules 218 and an equal number of pixel modules 224 that operate in parallel. Each geometry module and pixel module jointly control a different subset of the processing engines in multithreaded core array 202.

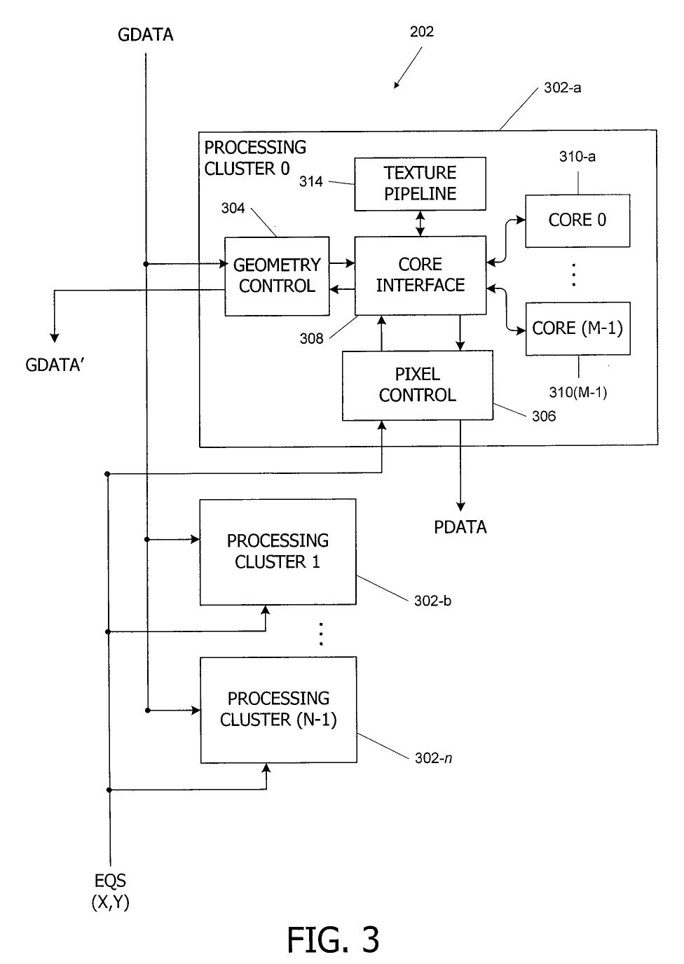

In one embodiment, multithreaded core array 202 provides a highly parallel architecture that supports concurrent execution of a large number of instances of vertex, geometry, and/or pixel shader programs in various combinations. FIG. 3 is a block diagram of multithreaded core array 202 according to an embodiment of the present invention.

In this embodiment, multithreaded core array 202 includes some number (N) of processing clusters 302. Herein, multiple instances of like objects are denoted with reference numbers identifying the object and parenthetical numbers identifying the instance where needed. Any number N (e.g., 1, 4, 8, or any other number) of processing clusters may be provided. In FIG. 3, one processing cluster 302 is shown in detail; it is to be understood that other processing clusters 302 can be of similar or identical design.

Each processing cluster 302 includes a geometry controller 304 (implementing geometry module 218 of FIG. 2) and a pixel controller 306 (implementing pixel module 224 of FIG. 2). Geometry controller 304 and pixel controller 306 each communicate with a core interface 308. Core interface 308 controls a number (M) of cores 310 that include the processing engines of multithreaded core array 202. Any number M (e.g., 1, 2, 4 or any other number) of cores 310 may be connected to a single core interface. Each core 310 is advantageously implemented as a multithreaded execution core capable of supporting a large number (e.g., 100 or more) of concurrent execution threads (where the term “thread” refers to an instance of a particular program executing on a particular set of input data), including a combination of vertex threads, geometry threads, and pixel threads.

Core interface 308 also controls a texture pipeline 314 that may be shared among cores 310. Texture pipeline 314, which may be of generally conventional design, advantageously includes logic circuits configured to receive texture coordinates, to fetch texture data corresponding to the texture coordinates from memory, and to filter the texture data according to various algorithms.

In operation, data assembler 206 (FIG. 2) provides geometry data GDATA (e.g., simplified vertex data for a particular primitive or group of primitives and, perhaps, associated rules data) to processing clusters 302. In one embodiment, data assembler 206 divides the incoming stream of geometry data into portions and selects, e.g., based on availability of execution resources, which of processing clusters 302 is to receive the next portion of the geometry data. That portion (e.g., a subset of the vertices of a primitive or group of primitives) is delivered to geometry controller 304 in the selected processing cluster 302.

Geometry controller 304 forwards received data to core interface 308, which loads the vertex data into a core 310, then instructs core 310 to launch the appropriate vertex shader program. Upon completion of the vertex shader program, core interface 308 signals geometry controller 304. If a geometry shader program is to be executed, geometry controller 304 instructs core interface 308 to launch the geometry shader program. Rules data may direct or otherwise indicate to the geometry controller 304 whether a geometry or vertex shader program should be launched, or if the programs are completed. In some embodiments, the processed vertex data is returned to geometry controller 304 upon completion of the vertex shader program, and geometry controller 304 instructs core interface 308 (e.g., according to rules data) to reload the data before executing the geometry shader program. Any vertex data for new vertices created by the geometry shader may be returned to the vertex shader for further execution (e.g., according to rules data). After completion of the vertex shader program and/or geometry shader programs, geometry controller 304 provides the processed geometry data (GDATA′) to setup module 208 of FIG. 2.

At the pixel stage, color assembly module 212 may divide the incoming stream of coverage data into portions and select, e.g., based on availability of execution resources or the location of the primitive in screen coordinates, which of processing clusters 302 is to receive the next portion of the data. That portion is delivered to pixel controller 306 in the selected processing cluster 302.

Pixel controller 306 delivers the data to core interface 308, which loads the pixel data into a core 310, then instructs the core 310 to launch the pixel shader program. As noted above, the pixel shader program may apply a normal map to data for the set of vertices which make up the more detailed representation of the simplified model. Where core 310 is multithreaded, pixel shader programs, geometry shader programs, and vertex shader programs can all be executed concurrently in the same core 310.

It will be appreciated that the multithreaded core array described herein is illustrative and that variations and modifications are possible. Any number of processing clusters may be provided, and each processing cluster may include any number of cores. In some embodiments, shaders of certain types may be restricted to executing in certain processing clusters or in certain cores; for instance, geometry shaders might be restricted to executing in core 310(0) of each processing cluster. Such design choices may be driven by considerations of hardware size and complexity versus performance, as is known in the art. A shared texture pipeline is also optional; in some embodiments, each core might have its own texture pipeline or might leverage general-purpose functional units to perform texture computations.

Data to be processed can be distributed to the processing clusters in various ways. In one embodiment, the data assembler (or other source of geometry data) and color assembly module (or other source of pixel-shader input data) receive information indicating the availability of processing clusters or individual cores to handle additional threads of various types and select a destination processing cluster or core for each thread. In another embodiment, input data is forwarded from one processing cluster to the next until a processing cluster with capacity to process the data accepts it. In still another embodiment, processing clusters are selected based on properties of the input data, such as the screen coordinates of pixels to be processed.

The multithreaded core array can also be leveraged to perform general-purpose computations that might or might not be related to rendering images. In one embodiment, any computation that can be expressed in a data-parallel decomposition (e.g., simplifying vertex data for a set of vertices, creating rules data to decompress the simplified vertex data, etc.) can be handled by the multithreaded core array as an array of threads executing in a single core. Results of such computations can be written to the frame buffer and read back into system memory.

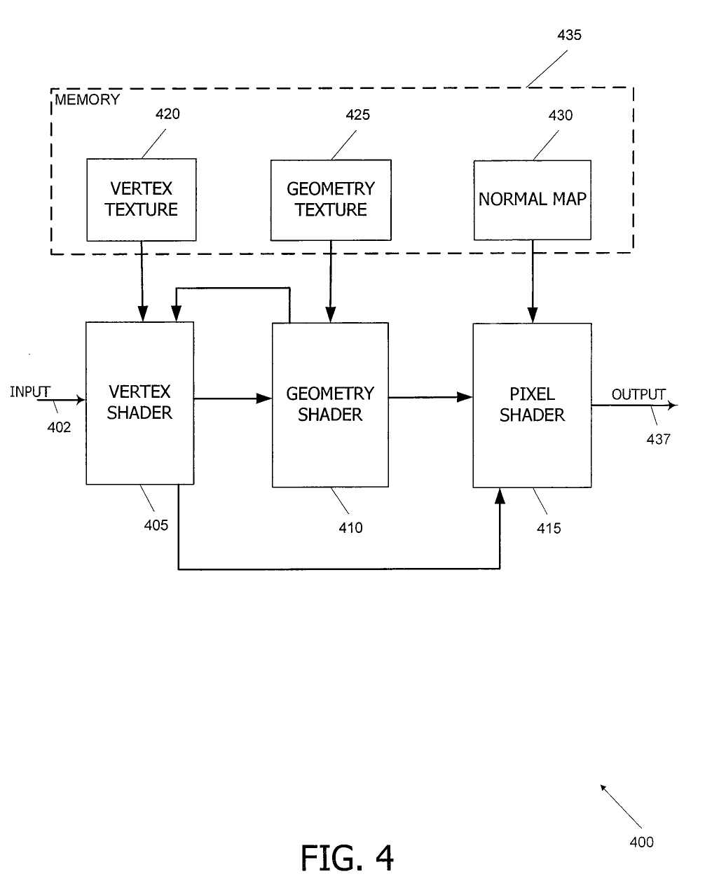

FIG. 4 is a block diagram of certain components 400 of a rendering pipeline, including a vertex shader 405, geometry shader 410, pixel shader 415, and memory 435. These components may, for example, be included in the rendering pipeline 200 implemented in GPU 122 of FIG. 1. They may be implemented using one or more shared processing engines in the multithreaded core array 202 of FIG. 3. Alternatively, they may be implemented as one, or more, Application Specific Integrated Circuits (ASICs) adapted to perform a subset of the applicable functions in hardware. In other embodiments, other types of integrated circuits may be used (e.g., Structured/Platform ASICs, Field Programmable Gate Arrays (FPGAs) and other Semi-Custom ICs), which may be programmed in any manner known in the art. Each may also be implemented, in whole or in part, with instructions embodied in a computer-readable medium, formatted to be executed by one or more general or application specific processors.

In one embodiment, vertex data 402 for a first set of vertices representative of a simplified model are received by the vertex shader 405. The vertex shader 405 performs any applicable transformations as described above. The vertex shader 405 may also perform lighting and shading, procedural geometry, and animation operations, e.g., by accessing memory 435 to retrieve vertex texture data 420. The geometry shader 410 is configured to receive and decompress the vertex data to create a more detailed representation of the simplified model. In one embodiment, the geometry shader is configured to subdivide the first set of vertices in the decompression of the vertex data to thereby create the more detailed representation. The geometry shader may, in one embodiment, be further configured to subdivide certain subsets of the vertices to different degrees. The geometry shader may be configured to access memory 435 to retrieve geometry texture data 425, and otherwise access instructions for executing the geometry shader program to decompress the received vertex data.

In one embodiment, the vertex shader 405 is further configured to receive a set of rules data including rules for the decompression of the simplified model. As noted above, this set of rules data may be included with per-vertex attributes associated with the vertex data for the set of vertices representative of the simplified model. The vertex shader 405 (or upstream processing units not shown) may pass the set of rules data to the geometry shader 410, including rules for the decompression of the simplified model. In the alternative, the rules data may be included with or otherwise integrated into state information, and accessed from memory 435 by the geometry shader 410.

As noted above, the geometry shader 410 may be configured to decompress the simplified model using the set of rules data. The set of rules data may include one or more of the following: a subdivision rule, tessellation rule, a texture rule, texture projection rule, edge rule, boundary rule, ray-casting rule, seam rule, other per-vertex attribute rule, or other parameter for the decompressing step. The set of rules data may include rules to be applied to only a subset of the first set of vertices. For example, the set of rules data may identify a first subset of the vertices which is to be subdivided to a greater level of detail than a second subset of vertices. In another embodiment, the set of rules data identifies rules to be applied only to certain additional vertices computed via the decompression, and not applied to the first set of vertices. Note also that in one embodiment, the set of rules data identifies parameters of the additional vertices to be computed, and the geometry shader 410 is configured to compute additional vertices in the creation of the more detailed representation.

Once the geometry shader 410 has computed additional vertices for the more detailed representation of the simplified model, the vertex data for the additional vertices may be returned to the vertex shader 405 for further execution (e.g., according to rules data). The data produced by the second pass through the vertex shader 405 may then be processed further by the geometry shader 410 or may be otherwise forwarded (e.g., according to rules data). Thus, the rules data may specify or otherwise indicate the number of passes through a vertex shader 405 or geometry shader 410. The passes may produce a more detailed representation of the simplified model.

Vertex data for the more detailed representation of the simplified model may then be forwarded to a pixel shader 415. The pixel shader 415, in addition to any conventional operations described above, may fetch a normal map 430 from memory 435. In other embodiments, displacement maps or other types of inputs may be used as well. The pixel shader 415 applies the normal map to the vertex data for the more detailed representation to create a further enhanced version 437 of the simplified model.

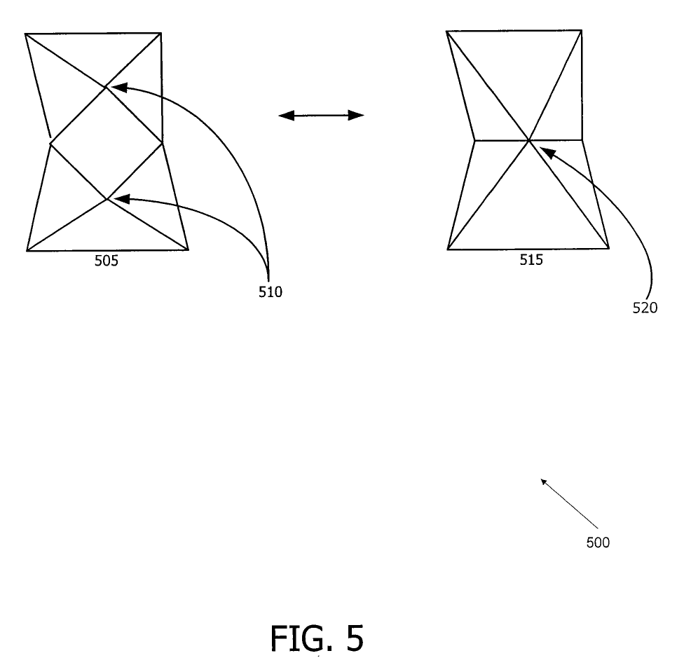

FIG. 5 is a diagram of two sets of vertices and their associated line segments 500, illustrating a basic example of the interaction between simplification and subdivision according to various embodiments of the invention. A first set 505 of vertices and a second set 515 of vertices are illustrated. In one embodiment, a vertex pair 510 is contracted to a new position 520 (e.g., using quadric error methods, volume, or EMIN) when a set of vertices is simplified. As noted above, in one embodiment this simplification is performed by the CPU 102 of the computer system 100 of FIG. 1. This process may be repeated for any number of contractions in a given set of vertices. Each contraction may be recorded, and stored within the set of rules data. The rules data may thus contain the information to undo a set of contractions (i.e., global geometry features may be preserved in the rules data). Alternatively, a geometry shader (e.g., the geometry shader 410 of FIG. 4) may be used to subdivide the simplified vertex data according to certain algorithms (e.g., using the inverse of the simplification algorithms).

In other embodiments, non-edge pairs may be collapsed in any manner known in the art, and other types of simplification algorithms may be used as well (e.g., vertex decimation, vertex clustering). Thus, a detailed set of vertices (e.g., a high resolution mesh) may be simplified into a reduced number of vertices representative of a simplified model in any manner known in the art. A geometry shader is then configured to subdivide or otherwise compute additional vertices to approximate the pre-existing high-resolution mesh (as used herein, “approximate” includes both lossy and non-lossy compression/decompression algorithms).

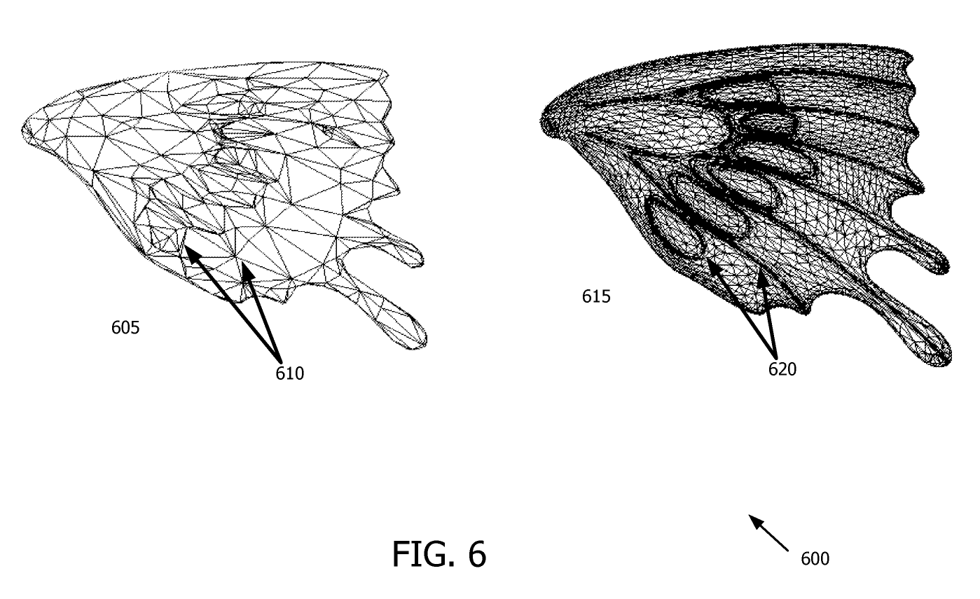

FIG. 6 is a diagram of two models 600 illustrating sets of vertices and their associated line segments. The individual models 605 each illustrate a wing and show the interaction between simplification and subdivision in more detailed models according to various embodiments of the invention. Models for a first set 605 and second set 615 of vertices are shown. In one embodiment, the second set 615 of vertices is simplified to created the first set 605. As noted above, the simplification may occur in any manner known in the art. In one embodiment this simplification is performed by the CPU 102 of the computer system 100 of FIG. 1. The simplification steps (in whole or in part) may be recorded, and stored within the set of rules data. The rules data may thus contain the information to undo a set of contractions or other simplification operations. Thus, the vertices of the first set 605 may be used, in conjunction with the rules data, to approximate the pre-existing high resolution mesh of the second set 615. Alternatively, a geometry shader (e.g., the geometry shader 410 of FIG. 4) may be preprogrammed to subdivide the simplified vertex data according to certain algorithms (e.g., the inverse of the simplification algorithms).

In other embodiments, certain subsets of vertices (e.g., certain regions) may be identified as having certain attributes. This identification may be included in the per-vertex attributes, or otherwise included in rules data. In one embodiment, the rules data identifies one or more subsets of vertices 610 that are to be subdivided to a greater level of detail 620 than other subsets of vertices. In this way, certain structural and or texture characteristics of the wing may be emphasized in the decompression. Similarly, certain features associated with certain subsets of vertices may be maintained or emphasized in the rules data (e.g., maintaining a sharp edge, a seam, a corner angle, a boundary, etc.).

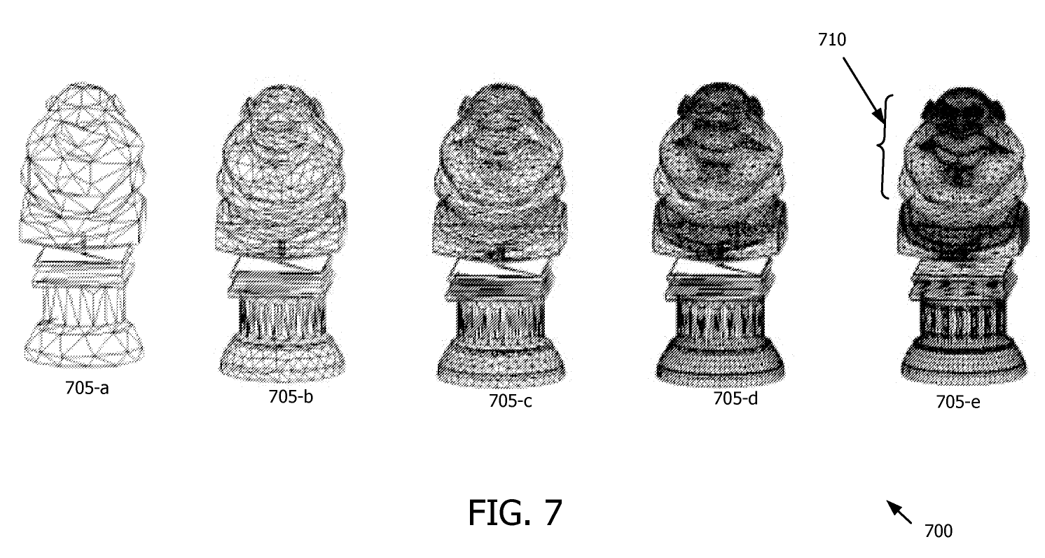

FIG. 7 is a diagram of a group of five models 700 illustrating sets of vertices and their associated line segments. The individual models 705 each illustrate a bust in different levels of detail according to various embodiments of the invention. Different sets 705 of vertices and their associated line segments are shown. In one embodiment, a high-resolution mesh 705-e is illustrated, and is simplified in a series of steps to create a set of vertices within a mesh 705-a representative of a simplified model. As noted above, the simplification may occur in any manner known in the art. In one embodiment this simplification is performed by the CPU 102 of the computer system 100 of FIG. 1. The simplification steps (in whole or in part) may be recorded, and stored within the set of rules data. The rules data may thus contain the information to undo a set of contractions or other simplification operations. The simplified set of vertices 705-a may be used, in conjunction with the rules data, to create different intermediate levels of detail (705-b, 705-c, 705-d, 705-e). Alternatively, a geometry shader (e.g., the geometry shader 410 of FIG. 4) may be preprogrammed to subdivide the simplified vertex data to different intermediate levels of detail (705-b, 705-c, 705-d, 705-e).

In some embodiments, certain subsets of vertices (e.g., certain regions) may be identified as having certain attributes. This identification may be included in the per-vertex attributes, or otherwise included in rules data. In one embodiment, the rules data identifies one or more subsets of vertices 710 (in this example 705-d, the face) that are to be subdivided to a greater level of detail than other subsets of vertices. In this way, certain structural and or texture characteristics of the bust may be emphasized in the decompression. Similarly, certain features associated with certain subsets of vertices may be identified via the rules data.

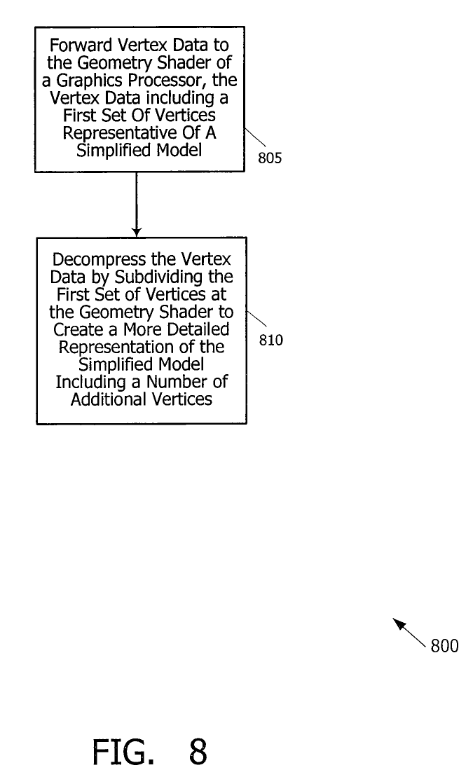

FIG. 8 is a flowchart illustrating a process 800 for decompressing vertex data according to various embodiments of the present invention. The process may, for example, be performed in whole or in part by the rendering pipeline 200 of FIG. 2. At block 805, vertex data is forwarded (e.g., by the vertex shader 405 of FIG. 4) to the geometry shader of a graphics processor (e.g., the geometry shader 410 of FIG. 4), the vertex data including a first set of vertices representative of a simplified model. At block 810, the geometry shader decompresses the vertex data by subdividing the first set of vertices to create a more detailed representation of the simplified model including a number of additional vertices. In other embodiments, the vertex data may be decompressed in other ways, as described above.

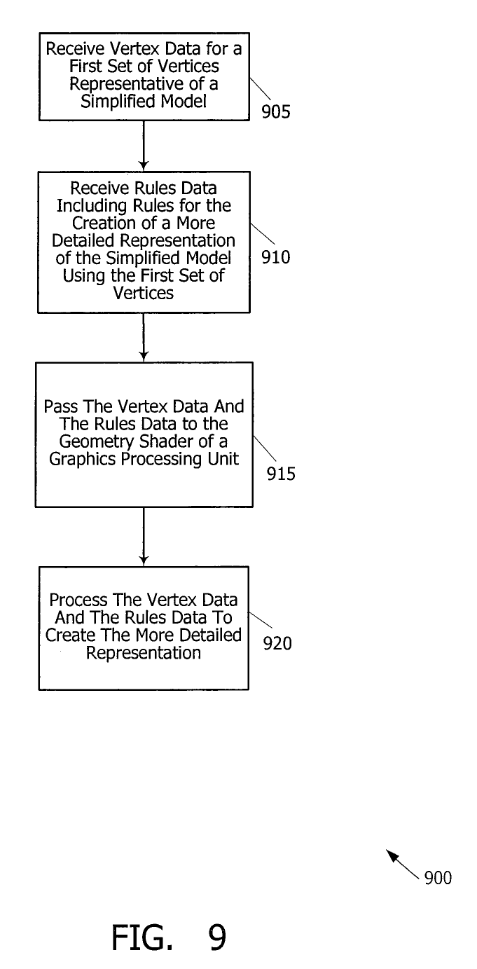

FIG. 9 is a flowchart illustrating an alternative process 900 for decompressing vertex data according to various embodiments of the present invention. As above, the process may be performed in whole or in part by the rendering pipeline 200 of FIG. 2. At block 905, vertex data is received (e.g., by the vertex shader 405 of FIG. 4) for a first set of vertices representative of a simplified model. At block 910, rules data is received (e.g., by the vertex shader 405 of FIG. 4), including rules for the creation of a more detailed representation of the simplified model using the first set of vertices. At block 915, the vertex data and the rules data are passed to the geometry shader (e.g., the geometry shader 410 of FIG. 4) of a graphics processing unit. At block 920, the vertex data and the rules data are processed to create the more detailed representation.

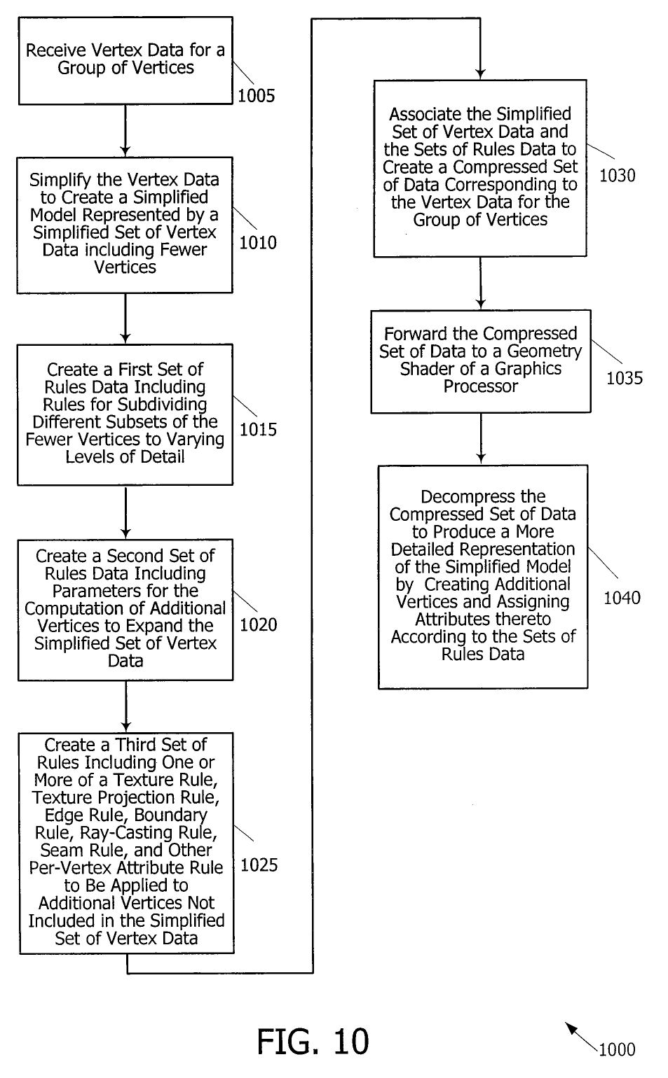

FIG. 10 is a flowchart illustrating a method of decompressing vertex data and creating additional vertices according to various embodiments of the present invention. The process may, for example, be performed in whole or in part by the components of the computer system 100 of FIG. 1. At block 1005, vertex data is received for a group of vertices. At block 1010, the received vertex data is simplified to create a simplified model represented by a set of vertex data including fewer vertices.

At block 1015, a first set of rules data is created, including rules for subdividing different subsets of the fewer vertices to varying levels of detail. At block 1020, a second set of rules is created including parameters for the computation of additional vertices to expand the simplified set of vertex data. At block 1025 a third set of rules data is created including one or more of a texture rule, texture projection rule, edge rule, boundary rule, ray-casting rule, seam rule, or other per-vertex attribute rule to be applied to additional vertices not included in the simplified set of vertex data.

At block 1030, the simplified set of vertex data is associated with the sets of rules data to create a compressed set of data corresponding to the vertex data for the group of vertices. At block 1035, the compressed set of data is forwarded to a geometry shader of a graphics processor (e.g., the GPU 122 of FIG. 1). At block 1040, the compressed set of data is decompressed to produce a more detailed representation of the simplified model by creating additional vertices and assigning attributes thereto according to the sets of rules data.

It should be noted that the methods, systems and devices discussed above are intended merely to be exemplary in nature. It must be stressed that various embodiments may omit, substitute, or add various procedures or components as appropriate. For instance, it should be appreciated that in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. Also, well-known circuits, processes, algorithms, structures, and techniques have been shown without unnecessary detail in order to avoid obscuring the embodiments.

It is noted that the embodiments may be described as a process which is depicted as a flowchart or a block diagram. Although these may describe the operations as a sequential process, many of the operations can be performed in parallel or concurrently. In addition, the order of the operations may be re-arranged. A process is terminated when its operations are completed, but could have additional steps not included in the figure.

Moreover, as disclosed herein, the term “memory” may represent one or more devices for storing data, including read only memory (ROM), random access memory (RAM), magnetic RAM, core memory, magnetic disk storage mediums, optical storage mediums, flash memory devices or other machine readable mediums for storing information. The term “machine-readable medium” includes, but is not limited to, portable or fixed storage devices, optical storage devices, wireless channels, a sim card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be required before the above elements are considered. Accordingly, the above description should not be taken as limiting the scope of the invention, which is defined in the following claims.

What is claimed is:

1. A graphics processor comprising:
one or more upstream processing units configured to pass vertex data for a first set of vertices representative of a simplified model; and
a geometry shader, coupled with the one or more upstream processing units, and configured to:
receive the vertex data; and
decompress the vertex data to create a more detailed representation of the simplified model.

2. The processor of claim 1, wherein the one or more upstream processing units comprise a vertex shader.

3. The processor of claim 1, wherein the geometry shader is configured to subdivide the first set of vertices in the decompression of the vertex data to thereby create the more detailed representation.

4. The processor of claim 1, wherein,
the one or more upstream processing units are further configured to pass a set of rules data including rules for the decompression of the simplified model; and
the geometry shader is configured to decompress the simplified model using the set of rules data.

5. The processor of claim 4, wherein the set of rules data comprises at least one of a subdivision rule, tessellation rule, texture rule, texture projection rule, edge rule, boundary rule, ray-casting rule, seam rule, other per-vertex attribute rule, or other parameter for the decompressing step.

6. The processor of claim 4, wherein the set of rules data includes rules to be applied to only a subset of the first set of vertices.

7. The processor of claim 4, wherein the set of rules data identifies a first subset of the first set of vertices which is to be subdivided to a greater level of detail than a second subset of the first set of vertices.

8. The processor of claim 4, wherein the set of rules data identifies rules to be applied to at least a subset of additional vertices computed via the decompression, and not applied to the first set of vertices.

9. The processor of claim 4, wherein the geometry shader is configured to compute additional vertices in the creation of the more detailed representation, and wherein the set of rules data identifies parameters of the additional vertices to be computed.

10. The processor of claim 4, wherein the set of rules data is included with per-vertex texture data passed from the one or more upstream processors to the geometry shader for processing.

11. The processor of claim 1, wherein the simplified model includes at least one of a set of triangles, quadrilaterals, and other polygons.

12. The processor of claim 1, further comprising:
a pixel shader, coupled with the one or more upstream processing units, and configured to apply a normal map to the more detailed representation of the simplified model, the normal map comprising differences between texture coordinates of the first set of vertices and texture coordinates of a detailed version of the simplified model.

13. The processor of claim 1, wherein the first set of vertices comprises a primitive.

14. A graphics processor comprising:
a vertex shader configured to:
receive vertex data for a first set of vertices representative of a simplified model;
receive rules data including rules for the creation of a more detailed representation of the simplified model using the first set of vertices; and
pass the vertex data and the rules data; and
a geometry shader, coupled with the vertex shader, and configured to:
receive the vertex data and the rules data; and
process the vertex data and the rules data to create the more detailed representation.

15. A method of processing vertex data, the method comprising;
passing vertex data for first set of vertices representative of a simplified model; and
decompressing the vertex data, in a geometry shader of a graphics processor, to create a more detailed representation of the simplified model including a plurality of additional vertices.

16. The method of claim 15, wherein the decompressing step comprises:
subdividing a first subset of the first set of vertices to a different degree than a second subset of the first set of vertices,
wherein the more detailed representation comprises a subdivided version of the simplified model.

17. The method of claim 15, further comprising
passing, to the geometry shader, a set of rules data including rules for the decompression of the simplified model,
wherein the geometry shader is configured to decompress the simplified model using the set of rules data.

18. The method of claim 17, wherein the set of rules data includes:
a first set of rules identifying a first subset of the first set of vertices which is to be subdivided to a greater level of detail than a second subset of the first set of vertices; and
a second set of rules identifying parameters for additional vertices to be computed.

19. The method of claim 17, further comprising:
creating the set of rules data.

20. The method of claim 15, further comprising:
simplifying vertex data for a second set of vertices to produce the simplified model, wherein the second set of vertices is greater in number than the first set of vertices; and
compressing the vertex data for the second set of vertices into a compressed set of data including the vertex data for the first set of vertices and rules data including rules for the decompression of the simplified model.
